(19) United States
(12) Patent Application Publication
(10) Pub. No.: US 2008/0231996 A1
(43) Pub. Date: Sep. 25, 2008

(54) VOICE COIL MOTORS AND MAGNETIC CIRCUITS THEREFOR

(76) Inventors: Hiroyuki YAMADA, Echizen-shi (JP); Daiki Kato, Echizen-shi (JP); Keiji Nagamiya, Echizen-shi (JP)

Correspondence Address: BIRCH STEWART KOLASCH & BIRCH, PO BOX 747, FALLS CHURCH, VA, 22040-0747, US

(21) Appl. No.: 12/051,323

(22) Filed: Mar. 19, 2008

(30) Foreign Application Priority Data
Mar. 20, 2007 (JP) 2007-072828

(51) Int. Cl. G11B 5/56

(52) U.S. Cl. 360/294.5

(57) ABSTRACT

Two magnet pieces of rectangular prism or parallelepiped prism shape are disposed on a yoke in an angle array to construct a magnetic circuit for a voice coil motor. The magnetic circuits facilitate positioning and holding of a moving coil, and the voice coil motor is improved in positioning precision of a magnetic head.

### CROSS-REFERENCE TO RELATED APPLICATION

This non-provisional application claims priority under 35 U.S.C. §119(a) on Patent Application No. 2007-072828 filed in Japan on Mar. 20, 2007, respectively, the entire contents of which are hereby incorporated by reference.

### TECHNICAL FIELD

This invention relates to voice coil motors for head positioning in magnetic disk units, and magnetic circuits for use therein.

### BACKGROUND OF THE INVENTION

In general, a hard disk unit includes a medium having a magnetic recording film deposited thereon, a spindle motor for rotating the medium at a predetermined rotational speed, a magnetic head for writing and reading information data, a voice coil motor (VCM) for driving the magnetic head, a controller and the like. The recent drastic price competition among manufacturers imposes a demand for further cost reduction on voice coil motors as well.

Referring to FIG. 1, a voice coil motor 10 includes magnetic material yokes 1, 1 and magnets (permanent magnets) 2 adhesively disposed thereon as described in JP-A 2004-23969. It is noted that the magnet adhesively disposed on the upper yoke 1 is omitted in FIG. 1 for simplicity of illustration. The yokes 1, 1 are coupled by magnetic material posts 5 such that magnets 2 face each other to define a space therebetween. A moving coil 3 on an arm 4 is located in the space between magnets 2. The voice coil motor 10 has a function of positioning a magnetic head. After magnets 2 are disposed on yokes 1, they are magnetized so as to produce alternate magnetic poles in the order of N and S.

The shape of magnets is generally determined depending on the required performance of a voice coil motor. Referring to FIG. 2, a magnetic disk unit 20 is illustrated which includes a generally rectangular housing 22 for receiving a magnetic disk 21. The disk unit 20 further includes a pivot 23, an arm 24, a magnetic head actuator 25, and a suspension 26. The voice coil motor 10 is typically disposed at one corner of housing 22. To comply with this geometry, the yoke 1 is configured to (1) a triangular shape, typically right-angled triangular shape, including side portions 11, 11 opposed to the adjacent walls defining the one corner of the rectangular housing 22, an apex 12 defined by side portions 11, 11, and a bottom 13 opposed to apex 12, (2) a frusto-triangular shape in which the apex of a triangle is truncated or rounded, or (3) an arcuate, crescent or semi-circular ring shape in which the bottom of a triangle at its center is recessed or cut-off in a semi-circular, triangular or apex-rounded triangular form. The magnet is also configured in conformity to the yoke 1, specifically to an arcuate, truncated arcuate or truncated inverse-V shape as illustrated in FIG. 3.

To form a magnet of an arcuate or similar shape, a mold of a corresponding shape must be prepared and worked such as by shaping, cutting, grinding or otherwise machining, which operation is expensive and less productive. In the event a magnet of an arcuate or similar shape is used, it is difficult to secure the magnet to the yoke at the registered position. A problem arises particularly in a compact magnetic disk unit because the accuracy of magnet registration has a substantial influence on the torque.

Also JP-A 6-178523 discloses a magnetic circuit including two trapezoid magnet pieces juxtaposed on a yoke. Trapezoid magnet pieces are worked and produced through many steps and hence in low yields.

### DISCLOSURE OF THE INVENTION

An object of the invention is to provide a magnetic circuit for a voice coil motor having the advantages of more accurate positioning of a magnetic head, minimized torque variation, and highly effective magnet production; and a voice coil motor.

It has been found that when the magnet pieces used in a voice coil motor are formed to a rectangular prism or parallelepiped prism shape and two of the magnet pieces are disposed in an angle array, there are achieved advantages of minimized torque variation and more accurate positioning of a magnetic head. The invention is predicated on this finding.

The invention provides a magnetic circuit and a voice coil motor as defined below.

[1] A magnetic circuit for a voice coil motor, comprising a magnetic material yoke and two magnet pieces of rectangular prism or parallelepiped prism shape disposed thereon in an angle array.
[2] A magnetic circuit for a voice coil motor, comprising a pair of opposed magnetic material yokes and a magnet disposed on at least one of the pair of yokes so that the magnet faces the other yoke, said magnet consisting of two magnet pieces of rectangular prism or parallelepiped prism shape which are arranged in an angle array so that the magnet pieces produce alternate magnetic poles.
[3] The magnetic circuit of [2], wherein the magnet is disposed on each of the pair of yokes so that the magnets face each other, each said magnet consisting of two magnet pieces of rectangular prism or parallelepiped prism shape which are arranged in an angle array so that the magnet pieces produce alternate magnetic poles.
[4] The magnetic circuit of any one of [1] to [3], wherein each magnet piece has a longitudinal axis, and an angle of 60° to less than 180° is included between the longitudinal axes of the two magnet pieces.
[5] A voice coil motor comprising a pair of opposed magnetic material yokes, a magnet disposed on at least one of the pair of yokes so that the magnet faces the other yoke, and a moving coil located between the magnet and the other yoke, wherein said magnet consists of two magnet pieces of rectangular prism or parallelepiped prism shape which are arranged in an angle array so that the magnet pieces produce alternate magnetic poles.
[6] The voice coil motor of [5], wherein the magnet is disposed on each of the pair of yokes so that the magnets face each other, each said magnet consisting of two magnet pieces of rectangular prism or parallelepiped prism shape which are arranged in an angle array so that the magnet pieces produce alternate magnetic poles. The moving coil is inserted into a space between the magnets each of which is disposed on each of the pair of yokes.

### BENEFITS OF THE INVENTION

Combination of two magnet pieces of rectangular prism or parallelepiped prism shape in an angular array with a yoke and a coil of proper shape provides a magnetic circuit which facilitates positioning and holding of the coil. The voice coil motor is more accurate in positioning the magnetic head.

### BRIEF DESCRIPTION OF THE DRAWINGS

FIG. 1 is an exploded perspective view of a voice coil motor (VCM).

FIG. 2 is a plan view of a magnetic disk unit.

FIG. 3 is a schematic plan view of a prior art VCM.

FIG. 4 schematically illustrates a VCM according to one embodiment of the invention, FIG. 4A being a plan view (taken along lines I-I in FIG. 4B) and FIG. 4B being an elevational view.

FIG. 5 is a schematic plan view of a VCM according to another embodiment of the invention.

FIG. 6 schematically illustrates a VCM according to a further embodiment of the invention, FIG. 6A being a plan view (taken along lines II-II in FIG. 6B) and FIG. 6B being an elevational view.

FIG. 7 schematically illustrates a coil torque measuring system.

FIG. 8 is a graph showing the coil torque of VCM as a function of angle.

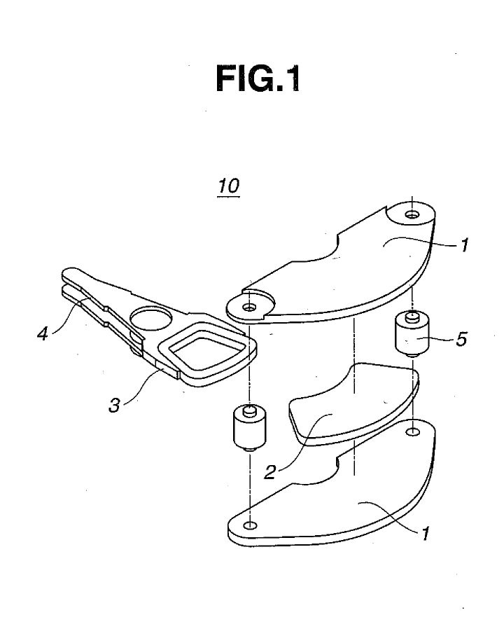

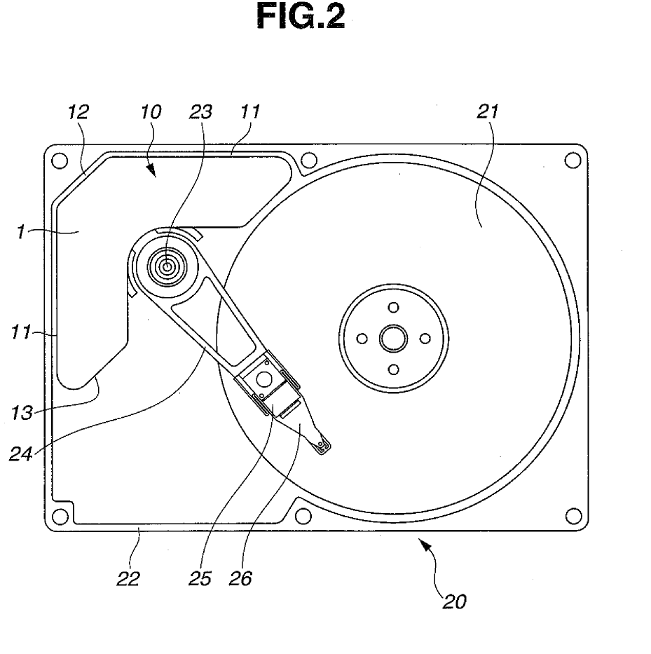

### DESCRIPTION OF THE PREFERRED EMBODIMENT

In the following description, like reference characters designate like or corresponding parts throughout the several views. It is also understood that terms such as “top,” “bottom,” “lateral” and the like are words of convenience and used as seen looking at a figure and are not to be construed as limiting terms.

Referring to FIG. 4, a voice coil motor (VCM) according to one embodiment of the invention is illustrated. The magnetic circuit of the invention is composed essentially of a magnetic material yoke and a magnet. As shown in FIGS. 4A and 4B, the VCM includes a pair of yokes 1a, 1b having magnets 2a, 2b adhesively attached thereto. The yokes 1a, 1b are coupled and spaced apart by posts 5 of magnetic material such that the magnets 2a and 2b face each other. A moving coil 3 is inserted into the space between magnets 2a, 2b to construct the VCM.

The VCM is characterized in that two magnet pieces of rectangular prism or parallelepiped prism shape are disposed on a yoke in an angle or chevron array so that the magnet pieces produce alternate magnetic poles.

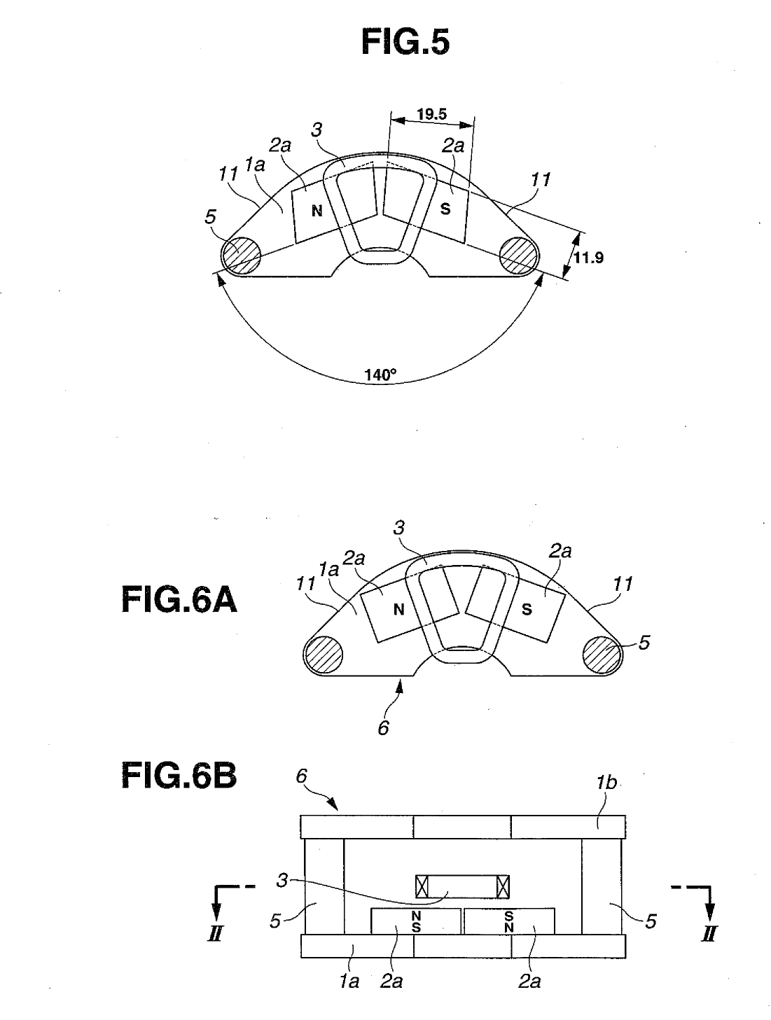

More specifically, in the embodiment of FIGS. 4A and 4B, two magnet pieces 2a, 2a (or 2b, 2b) are of rectangular prism shape. In another embodiment of FIG. 5, two magnet pieces 2a, 2a are of parallelepiped prism shape. It is understood that a magnet piece of rectangular or parallelepiped prism shape has a pair of major surfaces, a pair of end faces, and a pair of side faces. Where two magnet pieces of parallelepiped prism shape are used, they are arranged in an angle array while their end faces may be spaced apart or abutted each other (in a “̂” shape).

Although two magnet pieces 2a, 2b (or 2b, 2b) are disposed on each of opposed yokes 1a, 1b in the magnetic circuit and VCM of FIGS. 4A and 4B, it is also acceptable that as shown in FIGS. 6A and 6B, two magnet pieces 2a, 2a are disposed on only one yoke 1a in an angle array, no magnet piece is disposed on the other yoke 1b, and the other yoke 1b faces the magnet pieces 2a, 2a. In the latter case, the moving coil 3 is inserted between magnet pieces 2a, 2a and the other yoke 1b.

The yoke has a shape that fits in the magnetic disk unit and is disposed at one corner of a rectangular shaped housing for receiving a magnetic disk. The yoke is generally configured to a triangular shape, a frusto-triangular shape in which the apex of a triangle is truncated or rounded, or an arcuate, crescent or semi-circular ring shape in which the bottom of a triangle at its center is recessed or cut-off in a semi-circular, triangular or apex-rounded triangular form. The yoke is made of a magnetic material such as silicon steel or carbon steel and usually provided at lateral ends with holes through which posts or bolts are fitted to couple magnetic circuits together.

A magnet is registered and adhesively attached onto the yoke. According to the invention, the magnet has a rectangular prism shape (FIGS. 4 and 6) or parallelepiped prism shape (FIG. 5), which facilitates registration of the magnet relative to the yoke. By contrast, when a magnet has an arcuate or curved shape commonly employed in the prior art, registration of the magnet relative to the yoke is less easy, and any misregistration leads to a problem of torque variations.

The disposition of a magnet on a yoke is described. Two magnet pieces 2a, 2a each having a longitudinal axis are preferably disposed in an angle array such that the longitudinal axes of magnet pieces 2a, 2a are parallel or generally parallel to oblique sides 11, 11 of yoke 1. As shown in FIGS. 4 to 6, two magnet pieces are magnetized in a thickness direction to define N and S poles for each and disposed so that they produce alternate magnetic poles in the order of N and S.

Specifically, the longitudinal axes of two magnet pieces cross when extended. The angle included between the extensions of the longitudinal axes of two magnet pieces is not particularly limited. For the rectangular prism shape shown in FIGS. 4 and 6, the included angle is preferably in the range of 60° to less than 180°, and more preferably 900 to less than 180°. If the included angle is too smaller, a torque may be produced only in a limited range. Similarly for the parallelepiped prism shape shown in FIG. 5, the included angle is preferably in the range of 60° to less than 180°, and more preferably 90° to less than 180°.

As long as two magnet pieces are disposed at an angle, they may be spaced apart. It is preferable that two magnet pieces have the same shape. In some cases, however, two magnet pieces may not have the same shape for the reason of size reduction or the like.

Usually, the yoke is punched with bosses for registration of a magnet piece. In this case, the assembly is easier when two spaced-apart magnet pieces are disposed on the yoke.

For attachment of magnet pieces, heat resistant adhesives such as epoxy resins or acrylic resins are preferably used to attach the magnet pieces to the yoke.

The magnet (piece) used herein may have a rectangular prism or parallelepiped prism shape as mentioned above, with the rectangular prism shape being preferred from the working aspect. Ordinary magnets used in the industry include sintered magnets prepared from magnetizable raw materials by melting, grinding, molding and sintering, and bonded magnets prepared by melting, grinding, and resin-aided molding. This is also true in the invention. When a rectangular mold is used in the molding step, the molded part may be easily machined to the desired hexahedral structure. Then the yield of magnet working is improved. Magnets may be worked into a rectangular shape using a peripheral milling edge or wire saw.

As described above, either sintered magnets or bonded magnets may be used in the practice of the invention. They may be ferrite, alnico or rare earth magnets. In the case of rare earth magnets which are susceptible to oxidation, a plating of metal such as Ni or Cu or a coating of antioxidant is recommended.

In the embodiment of FIG. 4 wherein a pair of magnet pieces are disposed on each of two yokes, the magnetic circuits each consisting of a yoke and a magnet attached thereto are assembled so that the magnets face each other while they are spaced apart by magnetic material posts, and an arm having a moving coil wound thereon is inserted into the space defined between the magnetic circuits, constructing a VCM. In the embodiment of FIG. 6 wherein a pair of magnet pieces are disposed on one yoke, but not on the other yoke, the components are assembled so that the magnet pieces face the other yoke, and an arm having a moving coil wound thereon is inserted into the space defined between the magnet pieces and the other yoke, constructing a VCM. The magnetic circuits to be opposed should have the same properties. The resulting VCM operates in accordance with Fleming's rule to drive the moving coil for imparting thrust to the actuator.

### EXAMPLE

Examples of the invention are given below by way of illustration and not by way of limitation.

### Example 1

A Nd—Fe—B sintered magnetizable block (N48M by Shin-Etsu Chemical Co., Ltd.) was machined into rectangular prisms of 20.2 mm×11.9 mm×6 mm. Two pieces in an angle array were adhesively attached to a yoke of carbon steel having a thickness of 5 mm and then magnetized in a thickness direction by means of a magnetizer, so that the angle-arrayed magnet pieces produced alternate magnetic poles along the yoke. In this way, a magnetic circuit was constructed. The angle included between the longitudinal axes of two magnet pieces was 140°.

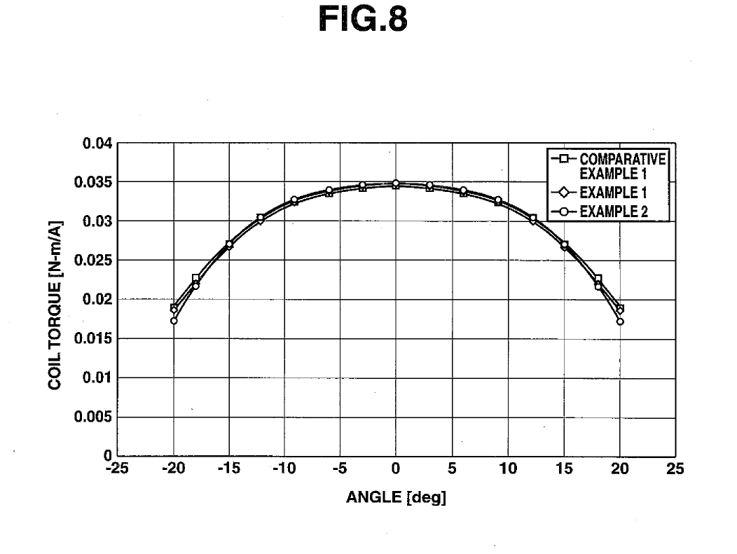

Two yokes (or magnetic circuits) were fixedly coupled by posts to define a space of 10 mm between the magnets. An arm having a moving coil of copper wire wound thereon was inserted into the space, constructing a VCM as shown in FIG. 4. The torque of VCM was measured with the results shown in FIG. 8.

### Example 2

A Nd—Fe—B sintered magnetizable block (N48M by Shin-Etsu Chemical Co., Ltd.) was machined into parallelepiped prisms of 19.5 mm×11.9 mm×6 mm. Two pieces in an angle array were adhesively attached to a yoke of carbon steel having a thickness of 5 mm and then magnetized in a thickness direction by means of a magnetizer, so that the angle-arrayed magnet pieces produced alternate magnetic poles along the yoke. In this way, a magnetic circuit was constructed. The angle included between the longitudinal axes of two magnet pieces was 140°.

Two yokes (or magnetic circuits) were fixedly coupled by posts to define a space of 10 mm between the magnets. An arm having a moving coil of copper wire wound thereon was inserted into the space, constructing a VCM as shown in FIG. 5. The torque of VCM was measured with the results shown in FIG. 8.

### Comparative Example 1

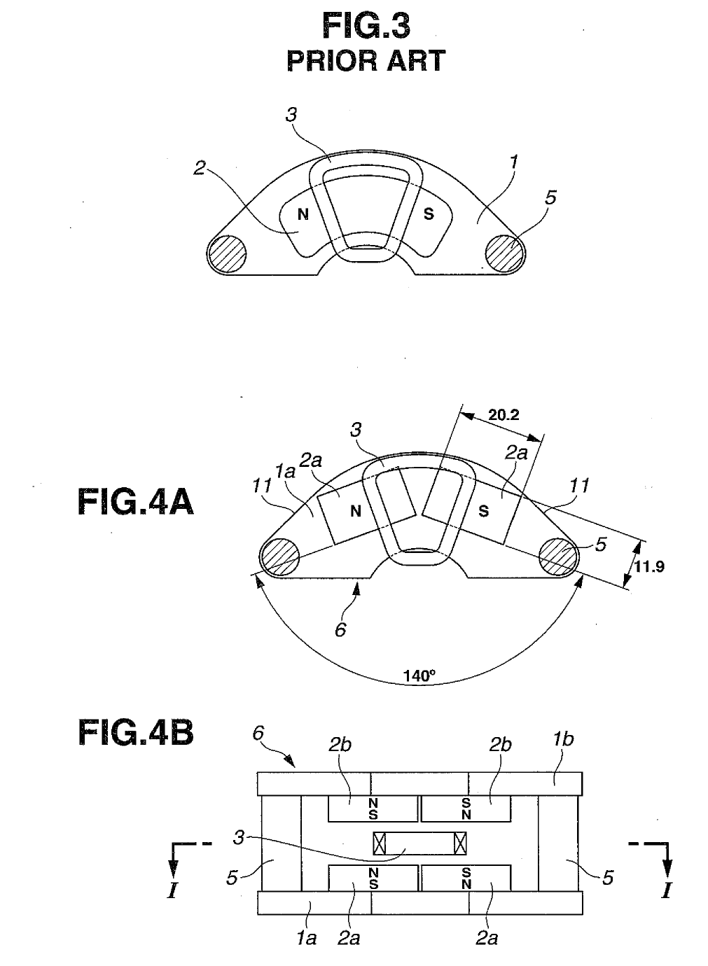

A magnetic circuit was constructed as in Example 1 except that one magnetizable piece of arcuate shape of R29×R16×6 mm×60° was used per yoke, and magnetized to define N and S poles in a planar direction. A VCM as shown in FIG. 3 was constructed and measured for torque, with the results shown in FIG. 8.

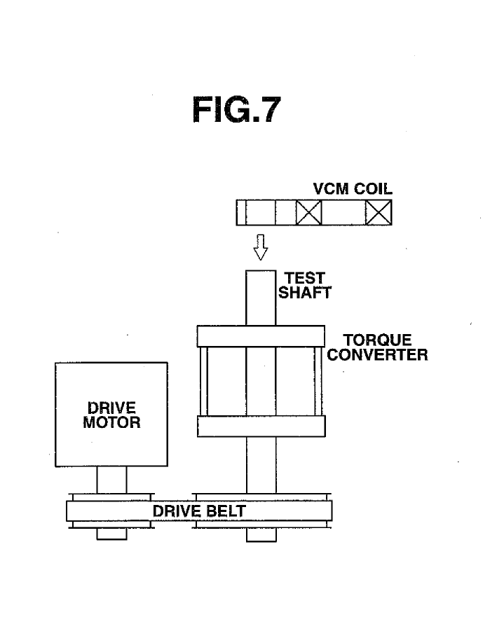

In the foregoing Examples and Comparative Example, the torque of VCM was measured by the following method. FIG. 7 illustrates a coil torque measuring system which includes a drive motor, a test shaft, a drive belt for operatively connecting the drive motor and the shaft, and a torque converter associated with the shaft. A VCM coil is mounted on the test shaft. The drive motor is operated to rotate the VCM coil while the torque is measured by the torque converter. The results are plotted in FIG. 8.

As seen from FIG. 8, a necessary torque is available when prism-shaped magnet pieces which can be efficiently produced at a relatively low cost are used and disposed in an angle array.

Japanese Patent Application No. 2007-072828 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A magnetic circuit for a voice coil motor, comprising a magnetic material yoke and two magnet pieces of rectangular prism or parallelepiped prism shape disposed thereon in an angle array.

2. A magnetic circuit for a voice coil motor, comprising
a pair of opposed magnetic material yokes and
a magnet disposed on at least one of the pair of yokes so that the magnet faces the other yoke,
said magnet consisting of two magnet pieces of rectangular prism or parallelepiped prism shape which are arranged in an angle array so that the magnet pieces produce alternate magnetic poles.

3. The magnetic circuit of claim 2, wherein the magnet is disposed on each of the pair of yokes so that the magnets face each other,
each said magnet consisting of two magnet pieces of rectangular prism or parallelepiped prism shape which are arranged in an angle array so that the magnet pieces produce alternate magnetic poles.

4. The magnetic circuit of claim 1, wherein each magnet piece has a longitudinal axis, and an angle of 60° to less than 180° is included between the longitudinal axes of the two magnet pieces.

5. A voice coil motor comprising
a pair of opposed magnetic material yokes,
a magnet disposed on at least one of the pair of yokes so that the magnet faces the other yoke, and
a moving coil located between the magnet and the other yoke, wherein
said magnet consists of two magnet pieces of rectangular prism or parallelepiped prism shape which are arranged in an angle array so that the magnet pieces produce alternate magnetic poles.

6. The voice coil motor of claim 5, wherein the magnet is disposed on each of the pair of yokes so that the magnets face each other,
each said magnet consisting of two magnet pieces of rectangular prism or parallelepiped prism shape which are arranged in an angle array so that the magnet pieces produce alternate magnetic poles.
